(19) United States
(12) Patent Application Publication
(10) Pub. No.: US 2025/0386145 A1
(43) Pub. Date: Dec. 18, 2025

(54) COAXIAL SPEAKER

(71) Applicant: Tymphany HK Limited, Hong Kong (HK)

(72) Inventor: Yu-Bing Zhan, Taipei City (TW)

(21) Appl. No.: 19/000,266

(22) Filed: Dec. 23, 2024

(30) Foreign Application Priority Data
Jun. 18, 2024 (CN) 202410788511.8

(51) Int. Cl. H04R 7/26

(52) U.S. Cl. CPC H04R 7/26

(57) ABSTRACT

A coaxial speaker includes a tweeter assembly, a woofer assembly, and a frame. The tweeter assembly is used to generate treble sound with a primary propagation direction along a first direction. The woofer assembly is used to generate bass sound with a primary propagation direction along the first direction. The woofer assembly includes a sound guide portion, which faces the tweeter assembly. The treble sound generated by the tweeter assembly, having a primary propagation direction along the first direction, is guided by the sound guide portion to propagate in a second direction. The tweeter assembly and woofer assembly are coaxially arranged, and the second direction is different from the first direction. The tweeter assembly and woofer assembly are mounted on the frame.

### CROSS-REFERENCE OF RELATED APPLICATIONS

This application claims priority of China Patent Application No. 2024107885118 filed on Jun. 18, 2024 under 35 U.S.C. § 119(a), the entire contents of all of which are hereby incorporated by reference.

### BACKGROUND

### 1. Technical Field

The present disclosure relates to the technical field of speakers, and particularly to a coaxial speaker.

### 2. Description of the Related Art

A coaxial speaker is a speaker in which a woofer and a tweeter are arranged along the same axis. The woofer and tweeter are responsible for producing low and high frequencies, respectively. Generally, the directions of motion of the woofer diaphragm and the tweeter diaphragm are the same, resulting in the main propagation direction of the sounds emitted by both the woofer and the tweeter being the same; i.e., the sound is primarily propagated in a single direction. Therefore, the prior art coaxial speakers have the limitation that the main sound propagation direction is limited to a single direction.

The information disclosed in this Background section is only for enhancement of understanding of the background of the described technology, and therefore, it may contain information that does not form the prior art that is already known to a person of ordinary skill in the art. Further, the information disclosed in the Background section does not mean that one or more problems to be resolved by one or more embodiments of the disclosure were acknowledged by a person of ordinary skill in the art.

### SUMMARY

The objective of this disclosure is to provide a coaxial speaker capable of propagating sound in at least two main propagation directions. The coaxial speaker comprises a tweeter assembly, a woofer assembly, and a frame. The tweeter assembly is used to generate treble sound with a primary propagation direction along a first direction. The woofer assembly is used to generate bass sound with a primary propagation direction along the first direction. The woofer assembly comprises a sound guide portion, which faces the tweeter assembly. The treble sound, generated by the tweeter assembly with the primary propagation direction along the first direction, is guided by the sound guide portion to propagate in a second direction. The tweeter assembly and the woofer assembly are coaxially arranged, and the second direction is different from the first direction. The tweeter assembly and the woofer assembly are disposed on the frame.

Optionally, the sound guide portion is a cone, and a cone angle of the sound guide portion is directed toward the tweeter assembly, with a gap between the sound guide portion and the tweeter assembly.

Optionally, the frame comprises a first sound outlet, and the treble sound propagates through the first sound outlet.

Optionally, the woofer assembly further comprises a woofer diaphragm, with the sound guide portion being part of the woofer diaphragm, and the woofer diaphragm is connected to the frame.

Optionally, the sound guide portion is a cone, and a cone angle of the sound guide portion is directed toward the tweeter assembly, with the sound guide portion and the woofer diaphragm coaxially arranged.

Optionally, the woofer assembly also comprises a woofer diaphragm support and a woofer voice coil, with the woofer diaphragm connected to the woofer diaphragm support and the woofer voice coil also connected to the woofer diaphragm support.

Optionally, the woofer diaphragm support comprises a second sound outlet, and the treble sound propagates through the second sound outlet.

Optionally, the woofer diaphragm and the woofer diaphragm support enclose an accommodation space, and the tweeter assembly is located within the accommodation space.

Optionally, the coaxial speaker further comprises a magnetic guide, with the tweeter assembly disposed on the magnetic guide, and the magnetic guide is located within the accommodation space.

Optionally, the woofer assembly further comprises a magnet, and the frame comprises a protruding portion, with the magnetic guide, the magnet, and the protruding portion sequentially in contact with each other.

Optionally, the coaxial speaker further comprises a first damper and a second damper, with the first damper connected to the magnetic guide, the first damper also connected to the woofer diaphragm support, the second damper connected to the woofer diaphragm support, and the second damper connected to the frame.

Optionally, the woofer diaphragm support further comprises a stepped portion, with the first damper and the second damper each connected to the stepped portion.

Optionally, the stepped portion is located at a middle position of a side wall of the woofer diaphragm support.

Optionally, the woofer diaphragm support further comprises a cylindrical portion, with the cylindrical portion coaxially arranged with the woofer voice coil.

By setting up the tweeter assembly, the woofer assembly, and the frame, the tweeter assembly is used to generate treble sound with a primary propagation direction along the first direction, and the woofer assembly is used to generate bass sound with a primary propagation direction along the first direction. The woofer assembly comprises the sound guide portion, which faces the tweeter assembly. The treble sound generated by the tweeter assembly with the primary propagation direction along the first direction is guided by the sound guide portion to propagate in a second direction, with the tweeter assembly and the woofer assembly coaxially arranged.

Because the woofer assembly can generate bass sound along the first direction and the treble sound generated by the tweeter assembly can be guided by the sound guide portion to propagate in the second direction, which differs from the first direction, the coaxial speaker can produce sound in at least two main propagation directions, avoiding the issue of the sound being propagated in a single direction as in conventional coaxial speakers.

The above description is a general summary of the technical aspects of the present application. To provide a clearer understanding of the technical methods and to facilitate their implementation, the following will provide a detailed description of the application, along with illustrations.

### BRIEF DESCRIPTION OF THE DRAWINGS

The accompanying drawings presented herein serve to deepen the understanding of the present application and are an integral part thereof. The illustrative embodiments and their explanations are provided to elucidate the present application and do not impose any undue limitations on it. In the drawings:

FIG. 1 is an exploded view of an embodiment of the coaxial speaker of the present invention (excluding the woofer diaphragm support);

FIG. 2 is a half-sectional view of an embodiment of the coaxial speaker of the present invention (excluding the woofer diaphragm support, frame, and second damper);

FIG. 3 is a half-sectional view of an embodiment of the coaxial speaker of the present invention;

FIG. 4 is an enlarged view of section A marked in FIG. 3;

FIG. 5 is an exploded view of the first damper, woofer diaphragm support, and second damper in an embodiment of the present invention; and

FIG. 6 is a perspective view of the woofer diaphragm, woofer diaphragm support, first damper, and tweeter diaphragm in an embodiment of the present invention.

### DETAILED DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

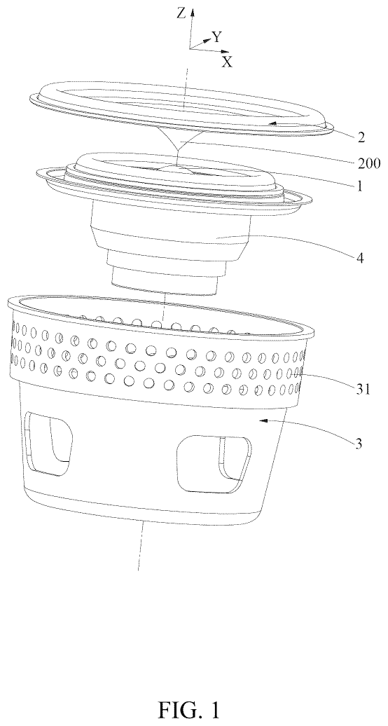

As shown in FIG. 1, an embodiment of the coaxial speaker is provided. The coaxial speaker of the present invention comprises a tweeter assembly 1, a woofer assembly 2, and a frame 3. The tweeter assembly 1 is used to generate treble sound with a primary propagation direction along the first direction. The woofer assembly 2 is used to generate bass sound with a primary propagation direction along the first direction. The woofer assembly 2 comprises a sound guide portion 200, which faces the tweeter assembly 1. The treble sound generated by the tweeter assembly 1, with the primary propagation direction along the first direction, is guided by the sound guide portion 200 to propagate in a second direction. The tweeter assembly 1 and the woofer assembly 2 are coaxially arranged, and the second direction is different from the first direction. Both the tweeter assembly 1 and woofer assembly 2 are disposed on the frame 3.

As shown in FIG. 1, to facilitate explanation, a rectangular coordinate system O-XYZ is established within the coaxial speaker. The central axes of the tweeter assembly 1 and woofer assembly 2 are coaxially aligned with the Z-axis. The X-axis or Y-axis is parallel to the radial direction of the sound guide portion 200. The sound guide portion 200 may have a curved surface, wherein the longitudinal section of the sound guide portion 200 appears curved when viewed from either the YoZ plane or XoZ plane. Alternatively, the sound guide portion 200 may have a conical surface, where its longitudinal section appears as a straight line when viewed from the YoZ or XoZ plane. The sound guide portion 200 may also have an inclined plane or other shapes, provided that its structure can redirect the treble sound from the tweeter assembly 1 such that the propagation direction is different from that of the bass sound produced by the woofer assembly 2.

As shown in FIG. 1, the tweeter assembly 1, the woofer assembly 2, and the frame 3 may be coaxially arranged. The sound guide portion 200 can be made of a solid, sound-reflective material. The materials of the sound guide portion 200 and woofer diaphragm 20 can be the same. For example, both the sound guide portion 200 and the woofer diaphragm 20 may be made of materials such as paper, plastic, metal, or synthetic fiber.

As shown in FIG. 1, because the woofer assembly 2 can produce bass sound with a primary propagation direction along the first direction, and the treble sound generated by the tweeter assembly 1 with a primary propagation direction along the first direction can be guided by the sound guide portion 200 to propagate in a second direction, which is different from the first direction, the coaxial speaker can produce sound propagating in at least two primary directions. This avoids the issue of sound emitted by the coaxial speaker propagating in only one primary direction. The primary propagation direction of the treble sound emitted by the tweeter assembly 1 and the primary propagation direction of the bass sound emitted by the woofer assembly can be in the Z-axis direction; i.e., the first direction can be the Z-axis direction. The second direction can form an angle with the first direction. For example, the second direction can form an angle with the Z-axis. That is, the treble sound emitted by the tweeter assembly 1, after being reflected by the sound guide portion 200, can propagate in a direction that forms an angle with the Z-axis.

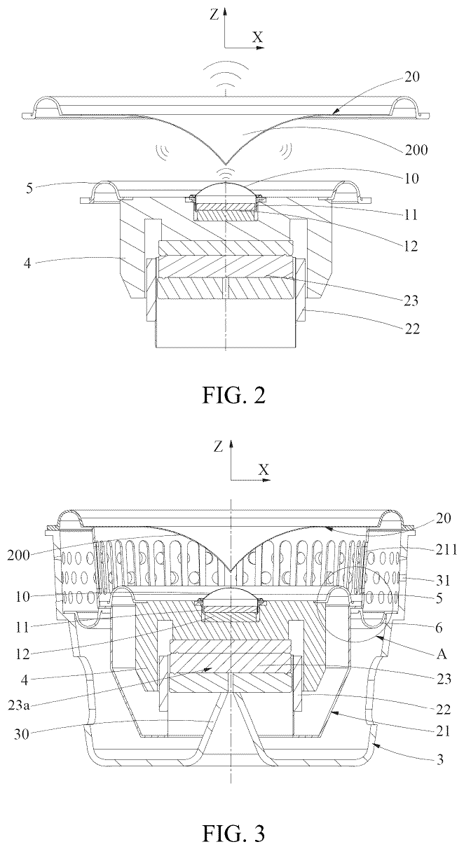

As shown in FIG. 2, both the tweeter assembly 1 (refer to FIG. 1 for tweeter assembly 1, same below) and the woofer assembly 2 (refer to FIG. 1 for woofer assembly 2, same below) emit sounds with a primary propagation direction and a secondary propagation direction. The sound volume is greatest in the primary propagation direction, while the volume in the secondary propagation direction is lower than that in the primary direction. FIG. 2 shows only the primary propagation direction of the treble sound emitted by the tweeter assembly 1 (represented by three smaller arc segments) and the primary propagation direction of the bass sound emitted by the woofer assembly 2 (represented by one larger arc segment). The secondary propagation directions of the treble sound emitted by the tweeter assembly 1 and the bass sound emitted by the woofer assembly 2 are not shown. The primary propagation direction of the treble sound emitted by the tweeter assembly 1 is the axial direction of the tweeter assembly 1. The primary propagation direction of the bass sound emitted by the woofer assembly 2 is the axial direction of the woofer assembly 2. The primary propagation direction of the treble sound generated by the tweeter assembly 1 can be represented by the direction of the central axis of the tweeter assembly 1 (e.g., the central axis of the tweeter assembly 1 may be the Z-axis). The primary propagation direction of the bass sound generated by the woofer assembly 2 can be represented by the direction of the central axis of the woofer assembly 2 (e.g., the central axis of the woofer assembly 2 may be the Z-axis).

As shown in FIG. 3, the tweeter assembly 1 (refer to FIG. 1 for tweeter assembly 1, same below) may comprise a tweeter diaphragm 10, a tweeter voice coil 11, and a first magnet 12. The tweeter diaphragm 10 is fixedly connected to the tweeter voice coil 11. The central axis of the tweeter diaphragm 10, the central axis of the tweeter voice coil 11, and the central axis of the first magnet 12 are coaxially aligned with the Z-axis. The tweeter voice coil 11 is embedded in the gap formed by the first magnet 12 and the magnetic guide 4. When the tweeter voice coil 11 is energized, the magnetic force generated by the first magnet 12 causes the tweeter diaphragm 10 to vibrate up and down along the Z-axis, thereby producing treble sound. That is, the tweeter assembly 1 generates treble sound that primarily propagates along the Z-axis direction.

As shown in FIG. 3, the woofer assembly 2 (refer to FIG. 1 for woofer assembly 2, same below) may comprise a woofer diaphragm 20, a woofer diaphragm support 21, a woofer voice coil 22, and a second magnet 23. The woofer voice coil 22 is embedded in the gap formed by the second magnet 23 and the magnetic guide 4. The central axis of the woofer diaphragm 20, the central axis of the woofer diaphragm support 21, the central axis of the woofer voice coil 22, and the central axis of the second magnet 23 are coaxially aligned with the Z-axis. The woofer diaphragm 20 is fixedly connected to the frame 3. The woofer diaphragm support 21 is fixedly connected to the woofer diaphragm 20. When the woofer voice coil 22 is energized, the magnetic force generated by the second magnet 23 drives the woofer diaphragm support 21 to move up and down along the Z-axis. When the woofer diaphragm support 21 moves up and down along the Z-axis, it causes the woofer diaphragm 20 to vibrate up and down, thereby producing bass sound. That is, the woofer assembly 2 generates bass sound that primarily propagates along the Z-axis direction.

As shown in FIG. 3, the tweeter assembly 1 and the woofer assembly 2 (refer to FIG. 1 for tweeter assembly 1 and woofer assembly 2, same below) are coaxially arranged. Therefore, the tweeter diaphragm 10, tweeter voice coil 11, the first magnet 12, the magnetic guide 4, the woofer diaphragm 20, the woofer diaphragm support 21, the woofer voice coil 22, and the second magnet 23 are coaxially arranged. The specific way in which the tweeter assembly 1 and woofer assembly 2 are disposed on the frame 3 can be referenced in the subsequent content of the embodiment.

As shown in FIG. 3, the woofer assembly 2 (refer to FIG. 1 for woofer assembly 2, same below) comprises a sound guide portion 200, which is part of the woofer assembly 2, making the sound guide portion 200 more compact and easier to install. Specifically, the sound guide portion 200 may be part of the woofer diaphragm 20. For example, the sound guide portion 200 may be integrally formed with the woofer diaphragm 20. Alternatively, the sound guide portion 200 can be fixed to the woofer diaphragm 20 by bonding, welding, or being integrally formed. Because the woofer diaphragm 20 can vibrate up and down along the Z-axis to produce bass sound, the sound guide portion 200, being part of the woofer diaphragm 20, can also direct the treble sound produced by the tweeter assembly 1 (refer to FIG. 1 for tweeter assembly 1, same below). Therefore, there is no need for a separate sound guide structure for the treble sound, making the sound guide portion 200 more compact and easier to install (once the woofer diaphragm 20 is installed, the sound guide portion 200 is also installed, eliminating the need for separate installation of the sound guide structure).

As shown in FIG. 3, optionally, the sound guide portion 200 is a cone, with its cone angle facing the tweeter assembly 1 (refer to FIG. 1 for tweeter assembly 1, same below). The sound guide portion 200 may be positioned above the tweeter assembly 1. The sound guide portion 200 and the tweeter assembly 1 are spaced apart, meaning they do not touch each other. The tweeter assembly comprises the tweeter diaphragm 10, which faces the cone angle of the sound guide portion 200, and the tweeter diaphragm 10 and the sound guide portion 200 are coaxially arranged. For example, the cone angle of the sound guide portion 200 may face the negative direction of the Z-axis, while the tweeter diaphragm 10 may protrude in the positive direction of the Z-axis. The tweeter diaphragm 10 and the sound guide portion 200 are coaxially aligned, and the conical shape of the sound guide portion 200 allows the treble sound generated by the tweeter diaphragm 10 to be more evenly reflected after it propagates in its primary propagation direction.

As shown in FIG. 3, the cone angle of the sound guide portion 200 can face the tweeter diaphragm 10, and the central axis of the sound guide portion 200 can be coaxially aligned with the tweeter diaphragm 10. In this way, the sound generated by the tweeter diaphragm 10 propagates in the primary propagation direction and is then guided by the sound guide portion 200 (for example, the sound generated by the tweeter diaphragm 10 in the primary propagation direction can be reflected by the sound guide portion 200). Afterward, the sound can propagate within the conical space, with the inner surface of the sound guide portion 200 serving as the apex of the cone.

As shown in FIG. 3, optionally, the woofer assembly 2 (refer to FIG. 1 for woofer assembly 2, same below) further comprises the woofer diaphragm 20, with the sound guide portion 200 being part of the woofer diaphragm 20, and the woofer diaphragm 20 is connected to the frame 3. The woofer diaphragm 20 may be fixed to the frame 3. For example, the outer edge of the woofer diaphragm 20 may be fixed to the top of the frame 3 through welding or bonding. The sound guide portion 200 is a cone, and the cone angle of the sound guide portion 200 faces the tweeter assembly 1 (refer to FIG. 1 for tweeter assembly 1), and the sound guide portion 200 is coaxially aligned with the woofer diaphragm 20. For example, the center part of the woofer diaphragm 20 may be recessed downward (e.g., toward the negative direction of the Z-axis) to form a conical sound guide portion 200, which may be a cone shaped formed of a membrane.

As shown in FIG. 3, optionally, the woofer assembly 2 (refer to FIG. 1 for woofer assembly 2, same below) further comprises a woofer diaphragm support 21 and a woofer voice coil 22. The woofer diaphragm 20 is connected to the woofer diaphragm support 21, and the woofer voice coil 22 is connected to the woofer diaphragm support 21. The woofer diaphragm support 21 is generally cup-shaped and is open at both ends. The upper portion of the woofer diaphragm support 21 covers the woofer diaphragm 20. The upper portion of the woofer diaphragm support 21 is fixed to the woofer diaphragm 20, either by welding or bonding. The woofer diaphragm support 21 is located between the magnetic guide 4 and the frame 3. The lower portion of the woofer diaphragm support 21 is fixed to the woofer voice coil 22, either by welding or bonding. The woofer diaphragm support 21 can be made of plastic, metal materials (e.g., aluminum alloy or magnesium-aluminum alloy), or synthetic fibers.

As shown in FIG. 3, optionally, the woofer diaphragm 20 and the woofer diaphragm support 21 form an enclosed accommodation space, and the tweeter assembly 1 (refer to FIG. 1 for tweeter assembly 1, same below) is positioned within the accommodation space. For example, after the upper end of the woofer diaphragm support 21 is fixed to the lower surface of the woofer diaphragm 20, a cylindrical accommodation space can be formed. The tweeter assembly 1 may be positioned centrally and slightly above this space by being fixed to the magnetic guide 4. Placing the tweeter assembly 1 within the enclosed space reduces the installation space as compared with an externally exposed tweeter assembly 1.

As shown in FIG. 3, optionally, the coaxial speaker further comprises a magnetic guide 4, with the tweeter assembly 1 (refer to FIG. 1 for tweeter assembly 1, same below) disposed on the magnetic guide 4. The magnetic guide 4 is located within the accommodation space. The first magnet 12 of the tweeter assembly 1 can be placed in a cylindrical groove at the top of the magnetic guide 4. The magnetic guide 4 can be positioned centrally and slightly below the top level of the accommodation space by being fixed to the magnet 23a and the protruding portion 30. The magnetic guide 4 can be a shared U-shaped structure (such as an U-yoke), meaning that the magnetic guide 4 can conduct magnetism for both the first magnet 12 and the second magnet 23. The magnetic guide 4 can be made of ferromagnetic steel material. Positioning the magnetic guide 4 inside the accommodation space reduces the installation space as compared with having the magnetic guide 4 exposed.

As shown in FIG. 3, optionally, the woofer assembly 2 (refer to FIG. 1 for woofer assembly 2, same below) further comprises a magnet 23a, and the frame 3 comprises a protruding portion 30. The magnetic guide 4, the magnet 23a, and the protruding portion 30 are sequentially in contact with each other. The magnet 23a may be the second magnet 23, and its shape may be cylindrical. The magnet 23a can be embedded in a cylindrical groove located at the bottom center of the magnetic guide 4. The upper end of the magnet 23a can be fixed to the magnetic guide 4, while the lower end can be fixed to the protruding portion 30. For example, after the magnetic guide 4, the magnet 23a, and the protruding portion 30 are sequentially in contact, adhesive can be applied to their contact surfaces for fixation. The protruding portion 30 may be disposed in the center of the bottom of the frame 3. The protruding portion 30 may take the form of a cone, a cylinder, or a rectangular body. The protruding portion 30 may also take other shapes, as long as it can pass through the bottom hole of the woofer diaphragm support 21 and provide support for the magnet 23a. The magnetic guide 4, the magnet 23a, and the protruding portion 30 are coaxially arranged. By setting the protruding portion 30 at the bottom of the frame 3, the magnet 23a and the magnetic guide 4 can be lifted away from the bottom of the frame 3, providing appropriate movement space for the woofer voice coil 22.

As shown in FIG. 3, optionally, the coaxial speaker further comprises a first damper 5 and a second damper 6. The first damper 5 connects the magnetic guide 4 and the woofer diaphragm support 21, while the second damper 6 connects the woofer diaphragm support 21 and the frame 3. Both the first damper 5 and the second damper 6 may have a ring shape with an arcuate cross-section. The inner edge of the first damper 5 can be fixed to the outer edge at the top of the magnetic guide 4, while the outer edge of the first damper 5 can be fixed to the inner wall of the woofer diaphragm support 21. The first damper 5 may be curved upward (e.g., in the positive direction of the Z-axis) and positioned inside the woofer diaphragm support 21. The first damper 5 can be fixed to the magnetic guide 4 and to the woofer diaphragm support 21 using bonding or welding.

As shown in FIG. 3, the inner edge of the second damper 6 can be fixed to the outer wall of the woofer diaphragm support 21, while the outer edge of the second damper 6 can be fixed to the inner wall of the frame 3. The second damper 6 may be curved downward (e.g., in the negative direction of the Z-axis) and positioned outside the woofer diaphragm support 21. The second damper 6 can be fixed to the woofer diaphragm support 21 and the frame 3 using bonding or welding. The first damper 5, the second damper 6, and the woofer diaphragm support 21 work together to maintain the vertical alignment of the woofer voice coil 22, preventing it from tilting.

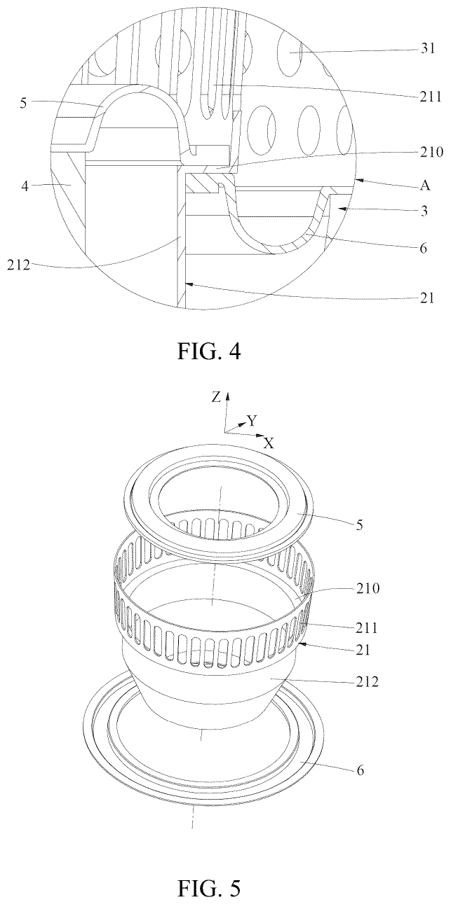

Referring to FIG. 4 and FIG. 5, optionally, the woofer diaphragm support 21 also comprises a stepped portion 210, with the first damper 5 and the second damper 6 connected to the stepped portion 210, respectively. The stepped portion 210 can be a flat circular ring, where the inner diameter of the woofer diaphragm support 21 above the stepped portion 210 is larger than the inner diameter of the woofer diaphragm support 21 below the stepped portion 210. The upper and lower surfaces of the stepped portion 210 can be flat. The ring-shaped stepped portion 210 can be coaxially aligned with the woofer diaphragm 20. The outer edge of the first damper 5 can be fixed to the upper surface of the stepped portion 210, while the inner edge of the second damper 6 can be fixed to the lower surface of the stepped portion 210. The first damper 5 and the second damper 6 can be fixed to the stepped portion 210 by bonding or welding.

Referring to FIG. 4 and FIG. 5, the design of the stepped portion 210 increases the contact area between the first damper 5, the second damper 6, and the woofer diaphragm support 21, thereby increasing the stability of the attachment of the first damper 5 and the second damper 6 to the woofer diaphragm support 21. Since both the first damper 5 and the second damper 6 are fixed to the stepped portion 210, they are approximately co-planar at the attachment point on the woofer diaphragm support 21. Therefore, the first damper 5 and the second damper 6 will not cause a bending movement on the woofer diaphragm support 21 due to being offset vertically, preventing the woofer diaphragm support 21 from tilting due to the bending movement. This helps the first damper 5, the second damper 6, and the woofer diaphragm support 21 keep the woofer voice coil 22 aligned vertically without tilting, ensuring more stable operation. The stepped portion 210 is positioned in the middle of the side wall of the woofer diaphragm support 21.

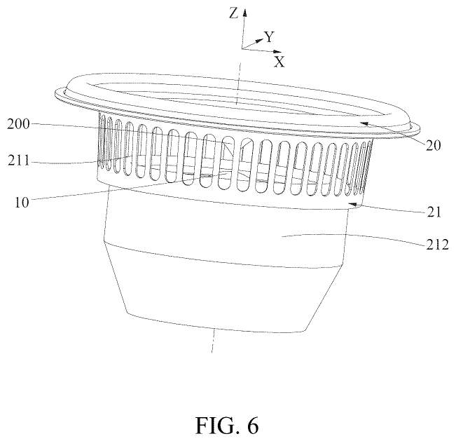

As shown in FIG. 6, optionally, the woofer diaphragm support 21 also comprises a second sound outlet 211, and the frame 3 comprises a first sound outlet 31 (refer to FIG. 3 for frame 3 and first sound outlet 31, same below). The treble sound propagates through the second sound outlet 211 and/or the first sound outlet 31. The second sound outlet 211 can be located on the side wall of the woofer diaphragm support 21 above the stepped portion 210 (refer to FIG. 5 for stepped portion 210). The shape of the second sound outlet 211 may be a rectangular slot. There can be multiple second sound outlets 211, and they can be uniformly distributed along the side wall of the woofer diaphragm support 21 with reference to the Z-axis.

As shown in FIG. 1, the first sound outlet 31 can be located on the frame 3 above the stepped portion 210 (refer to FIG. 5 for stepped portion 210). The first sound outlet 31 may be circular in shape. There can be multiple first sound outlets 31, and they can be uniformly distributed along the side wall of the frame 3 with reference to the Z-axis. The second sound outlet 211 (refer to FIG. 5 for second sound outlet 211, same below) is larger in size than the first sound outlet 31. The second sound outlet 211 and the first sound outlet 31 connect the accommodation space with the external space. The number of second sound outlets 211 is fewer than the number of first sound outlets 31. The treble sound generated by the tweeter assembly 1 and the treble sound reflected and redirected by the sound guide portion 200 can propagate outward (e.g., in the direction of the X-axis or Y-axis) through the second sound outlet 211 and the first sound outlet 31.

As shown in FIG. 6, optionally, the woofer diaphragm support 21 further comprises a cylindrical portion 212, which is coaxially aligned with the woofer voice coil 22 (refer to FIG. 3 for woofer voice coil 22, same below). The cylindrical portion 212 can be tube-shaped. The top of the cylindrical portion 212 can be fixed to the inner side of the stepped portion 210 (refer to FIG. 4 for stepped portion 210, same below). For example, the cylindrical portion 212 and the stepped portion 210 can be integrally formed. Because the woofer voice coil 22 primarily moves in the axial direction along the Z-axis, the coaxial arrangement of the cylindrical portion 212 and the woofer voice coil 22 ensures that the force of the woofer voice coil 22 is transmitted along the Z-axis to the woofer diaphragm 20, preventing any force from being wasted in a radial direction (e.g., along the X-axis or Y-axis) and thus increasing the efficiency of the force transmission of the woofer voice coil 22.

The foregoing description of the preferred embodiments of the invention has been presented for purposes of illustration and description. It is not intended to be exhaustive or to limit the invention to a precise form or to the exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. before a noun or element. Such terms should be understood as nomenclature and should not be construed as giving the limitation on the number of the elements modified by such nomenclature unless a specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element or component in the present disclosure is intended to be dedicated to the public regardless of whether the element or component is explicitly recited in the following claims.

1. A coaxial speaker, comprising:
a tweeter assembly for generating treble sound with a primary propagation direction along a first direction;
a woofer assembly for generating bass sound with a primary propagation direction along the first direction, the woofer assembly comprising a sound guide portion directed toward the tweeter assembly, wherein the treble sound generated by the tweeter assembly, with the primary propagation direction along the first direction, is guided by the sound guide portion to propagate in a second direction, wherein the tweeter assembly and woofer assembly are coaxially arranged and the second direction differs from the first direction; and
a frame, wherein the tweeter assembly and the woofer assembly are disposed on the frame.

2. The coaxial speaker as claimed in claim 1, wherein the sound guide portion is a cone, and a cone angle of the sound guide portion is directed toward the tweeter assembly, with a gap between the sound guide portion and the tweeter assembly.

3. The coaxial speaker as claimed in claim 1, wherein the frame comprises a first sound outlet, and the treble sound propagates through the first sound outlet.

4. The coaxial speaker as claimed in claim 1, wherein the woofer assembly further comprises a woofer diaphragm, the sound guide portion is a part of the woofer diaphragm, and the woofer diaphragm is connected to the frame.

5. The coaxial speaker as claimed in claim 4, wherein the sound guide portion is a cone, and a cone angle of the sound guide portion is directed toward the tweeter assembly, with the sound guide portion and the woofer diaphragm coaxially arranged.

6. The coaxial speaker as claimed in claim 4, wherein the woofer assembly further comprises:
a woofer diaphragm support; and
a woofer voice coil connected to the woofer diaphragm support,
wherein the woofer diaphragm is connected to the woofer diaphragm support.

7. The coaxial speaker as claimed in claim 6, wherein the woofer diaphragm support comprises a second sound outlet, and the treble sound propagates through the second sound outlet.

8. The coaxial speaker as claimed in claim 6, wherein the woofer diaphragm and the woofer diaphragm support enclose an accommodation space, and the tweeter assembly is located within the accommodation space.

9. The coaxial speaker as claimed in claim 8, further comprising a magnetic guide,
wherein the tweeter assembly is disposed on the magnetic guide and the magnetic guide is located within the accommodation space.

10. The coaxial speaker as claimed in claim 9, wherein the woofer assembly further comprises a magnet,
wherein the frame further comprises a protruding portion, and
wherein the magnetic guide, the magnet, and the protruding portion are sequentially in contact with each other.

11. The coaxial speaker as claimed in claim 9, wherein a first magnet of the tweeter assembly is placed in a cylindrical groove at the top of the magnetic guide,
wherein the magnetic guide is positioned in an accommodation space by being fixed to the magnet and the protruding portion,
wherein the magnetic guide is a shared U-shaped magnet, and
wherein the magnetic guide conducts magnetism for both the first magnet and the second magnet.

12. The coaxial speaker as claimed in claim 9, further comprising:
a first damper connected to the magnetic guide and to the woofer diaphragm support; and
a second damper connected to the woofer diaphragm support and to the frame.

13. The coaxial speaker as claimed in claim 11, wherein the woofer diaphragm support further comprises a stepped portion,
wherein the first damper and second damper are each connected to the stepped portion.

14. The coaxial speaker as claimed in claim 12, wherein the stepped portion is located at a middle position of a sidewall of the woofer diaphragm support.

15. The coaxial speaker as claimed in claim 6, wherein the woofer diaphragm support further comprises a cylindrical portion coaxially arranged with the woofer voice coil.
